(19) United States
(12) Patent Application Publication
(10) Pub. No.: US 2007/0268525 A1
(43) Pub. Date: Nov. 22, 2007

(54) Simultaneous Individual and Coupled Error Diffusion

(76) Inventors: Scott Michael Heydinger, Lexington, KY (US); Randall David Mayo, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/383,607

(22) Filed: May 16, 2006

(51) Int. Cl. G06F 15/00; G06K 15/00

(52) U.S. Cl. 358/3.06; 358/1.9

(57) ABSTRACT

A system for halftoning an color image that includes first and second primary colors is disclosed. The system includes a first input-dependent threshold generator that generates a threshold based on the first color. The system further includes a second input-dependent threshold generator that generates a threshold based on sum of the first color and the second color.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates to digital image processing. More particularly, the present invention relates to digital halftoning using simultaneous individual and coupled error diffusion.

2. Description of Related Art

Digital halftoning reduces the number of pixel levels used to represent an image to a smaller number of pixel levels that can actually be displayed by a real display device such as a printer. For example, 24 bits are commonly used to represent the color information for each pixel of a color image, 8 bits each for the primary colors red, green, and blue. To print such images on a binary, 3 primary color, ink-jet printer, the 24-bit red, green and blue information is first converted to 24 bits of cyan, magenta, and yellow information, 8 bits each for cyan, magenta, and yellow, by techniques known in the art. Eight bits specify 256 levels of colorant for each of these printable primaries.

A binary ink-jet printer, however, can print only 2 levels of each colorant at each pixel location. A halftoning algorithm is therefore employed to make the decision to print or to not print a dot of each of the primaries at each pixel location, given the original 256 levels of information for each primary. The resulting information then consists of three planes of dot information, corresponding to pixel locations at which cyan, magenta, and yellow dots are to be placed.

Though binary printers can represent only two levels of information at a given pixel location, halftoning algorithms produce patterns of dots over wide areas to simulate the appearance of a much larger number of shades. Therefore, if a solid color is to be produced over a wide area, a noticeable pattern of dots may be used to represent the color. The degree to which the pattern is noticeable is governed by, among other things, the contract ratio between the color of the dots themselves and the color that surrounds them. The contrast ratio is the ratio of the darkness of the dots to the darkness of the color which surrounds them. The bigger the difference, the more noticeable the dots. For similar patterns of black and yellow dots printed on white paper, the pattern of black dots will be more noticeable than the pattern of yellow dots since black is much darker than white, and yellow is only slightly darker than white.

One known halftoning algorithm is error diffusion. Error diffusion works by spreading the inaccuracy, or error, of the halftone decision at one pixel in the output image among nearby pixels, creating a visually superior transformation. Each original pixel value is adjusted based on the error contributed by adjacent and nearby pixels, and these contributions are taken into account in calculating the correct transformed value for the pixel.

Error diffusion is a preferred halftone algorithm because of two important pattern quality criteria:

Error diffusion produces a randomized pattern of dots; and

Error diffusion produces a pattern that has the dots maximally spread apart from one another.

For a variety of reasons, these properties are important in making images out of patterns of dots and hiding the undesirable pattern from the human visual system so that the image looks smooth like a real photograph.

FIG. 1 is a block diagram of an prior art apparatus that can implement an error diffusion halftone technique. An 8bit cyan input 10 value (a typical printer would include a separate identical apparatus for magenta and yellow) for a specific pixel location is received by adder 16. Adder 16 also receives an error signal from an error buffer 22 (which stores an error spreading value from a previously calculated pixel), which is summed with cyan input 10. Adder 16 supplies the modified value to a comparator 14. The modified value received from adder 16 is thus made up of the initial cyan density value, which can vary from 0 to 255 depending on the intensity or density of the pixel being scanned, modified by the error correction value from error storage 22.

Comparator 14 compares the value from adder 16 with a threshold value “threshold” generated by threshold generator 12 and provides a Print/No Print decision 17. The threshold value may be constant (e.g., 127.5, the midpoint is 0 and 255) or may vary based on cyan input 10 or some other factors.

When the value of the signal from adder 16 exceeds the threshold value, comparator 14 provides a “print” decision, which corresponds to a value of 255, on output line 15. A cyan dot having a value of 255 will then be printed by the printer at the pixel location. When the value of the signal from adder 16 does not exceed the threshold value, comparator 14 provides a “no print” decision, which corresponds to a value of 0, on output line 15, resulting in no cyan dot being printed at the pixel location.

This value on output line 15 (either 0 or 255) is subtracted from the output of adder 16 at an adder 18. This generates the error value “error” on error line 19 that is input to error weight application module 20, which receives an error weight from error weight generation module 24. Error weight generation module 24 can assign a spread error weight using any known allocation, including using cyan 10 as an input. Once known set of weights is disclosed in Robert Floyd and Louis Steinberg, “An Adaptive Algorithm for Spatial Grayscale”, 1975 ISD International Symposium, Digest of Technical Papers, pp. 36-37. According to the Floyd-Steinberg disclosed method of error diffusion, the error E is diffused to neighboring pixels that have not yet been binarized, thereby modifying their colorant values. The error generated at a pixel location (x, y) is therefore added to neighboring 8-bit pixel values according the following weights proposed by Floyd and Steinberg: E* 7/16 to location (x+1, y), E* 1/16 to location (x+1, y+1), E* 5/16 to location (x, y+1), and E* 3/16 to location (x−1, y+1). Error weight application module 20 applies the weights and stores the generated error diffusion value at error buffer 22, where it is added to the next calculated input cyan value for subsequent pixels.

One problem with most know error diffusion (and other halftone algorithms) is that they were developed under the assumption of printing with one type of dot, typically black dots. This is historical in nature in that laser printers and early ink-jet printers utilized only black toner or ink. Therefore, for example, the computations of the placement of cyan and magenta planes are performed independent of one another. However, the combined pattern frequently does not meet the second pattern quality criteria of separating all of the dots. Sometimes, cyan and magenta dots actually touch and in general may overlap.

However, more recent print technologies employ the use of multiple kinds of dots, including color dots such as cyan and magenta, and multiple drop sizes such as large cyan and small cyan. Though halftone algorithms have been traditionally optimized with respect to a single kind of drop, output documents are not longer viewed as a pattern of just one type of drop but as a conglomeration of multiple types of drops that vary either in types of ink or size.

Given that images are formed an viewed as a collection of multiple types of drops that are mixed together instead of viewing the individual types of drops by themselves, there is an interest in optimizing halftone algorithms to optimize multiple types of drops in conjunction with each other rather than individually as previously. U.S. Pat. Nos. 6,363,172 and 5,973,803 disclose methods of combining drops of a plurality of types of ink, namely cyan, magenta and optionally black, to form an optimal pattern of all of these kinds of dots rather than computing optimal patterns individually and then combining the results. This is motivated by the known fact that patterns that are optimal individually are not necessarily optimal when combined.

The general idea of these “combined halftoning” patents is primarily to add the number of drops from the individual planes to make an ideal pattern of the sum, and secondarily assuring that within the pattern the percentages of each type of dot are adhered to.

In the technique of combined color halftoning, the sum of the modified errors is compared against a threshold to determine whether or not to print a dot. Secondarily, once a dot (independent of the type) is determined to be printed, another comparison of the modified values is used to determine which type to print. Since the mechanism of comparison against a threshold and spreading of errors is important to meeting the two pattern quality criteria, and further since the combined color halftoning criteria is to make a randomized, optimally spread pattern of the sum total of the drops of the various types, the threshold and spread factors are now dependent on the sum of the original colorant values.

The combined color halftoning technique is motivated by the fact that it is more important to optimize the combined pattern of different types of drops since the combined patterns, not the individual patterns, are viewed by the user. However, in a combined pattern, the individual planes typically still are somewhat visible to the human eye, particularly if the different kinds of drops are different drop sizes.

Based on the foregoing, there is a need for an advanced method of combined color halftoning that causes both the combined and individual color planes to meet the pattern quality criteria.

### SUMMARY OF THE INVENTION

One embodiment of the present invention is a system for halftoning an color image that includes first and second primary colors. The system includes a first input-dependent threshold generator that generates a threshold based on the first color. The system further includes a second input-dependent threshold generator that generates a threshold based on sum of the first color and the second color.

### BRIEF DESCRIPTION OF THE DRAWINGS

FIG. 1 is a block diagram of an prior art apparatus that can implement an error diffusion halftone technique.

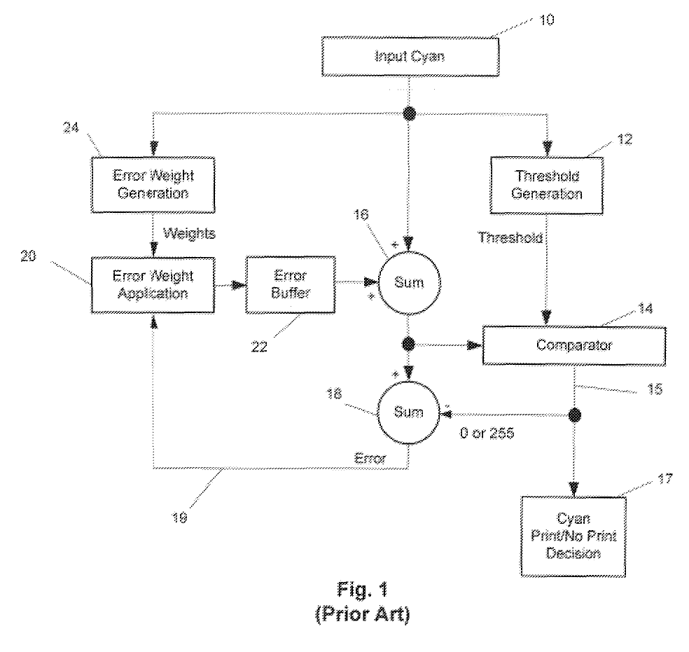

FIG. 2 is a block diagram of a printing system in accordance with one embodiment of the present invention for making a print decision based on a magenta input and a cyan input for a specific pixel location.

FIG. 3 is a block diagram of a printing system in accordance with one embodiment of the present invention for making a print decision based on a magenta input and a cyan input for a specific pixel location that includes only two error buffers.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible.

The term output as used herein encompasses output from any printing device such as a copier, a printer, or a so-called “all-in-one device” which incorporates multiple functions such as scanning, copying, and printing capabilities in one device. Such printing devices may utilize ink jet, dot matrix, dye sublimation, laser, and any other suitable print formats.

One embodiment of the present invention is directed to halftoning an input image using error diffusion so that both the combined and individual color planes meet the pattern quality criteria. In one embodiment, at least two spread error weights and at least two thresholds are based on an input pixel value.

One embodiment of the present invention is based on the following ideas:

(a) The prior art combined color halftone method functions well to produce an optimal pattern of combined dot types. Embodiments of the present invention maintain this desired property. The combined color halftone method has a primary problem of determining how to make an optimal pattern of the sum of the number of dots from the individual dot planes, i.e., when to print a dot independent of the dot type, and a secondary problem of determining which of the dot types to print when it is determined to actually print one of the types of dots.

(b) The prior art standard error diffusion halftone algorithm functions well to produce a pattern of a single dot type. Embodiments of the present invention maintain this desired property to make a pleasing pattern of one, and possibly more, of the individual dot types.

A first embodiment of the present invention, therefore, includes two error diffusion mechanisms (i.e., two “spread” functions to maintain error) to satisfy the primary problem of determining when to print a dot independent of the dot type. The spread functions take as an input the sum of the number of drops in the individual dot planes.

In addition, a first embodiment of the present invention includes a third error diffusion mechanism to satisfy the secondary problem of determining which of the types of dots to print when it is determined to actually print one of the types of dots. The input of the third spread function is the number of drops of one of the individual planes. For example, if the drop types include cyan and magenta drops, and assuming that cyan drops are somewhat more visible than magenta drops, then the third spread function will have as an input the number of cyan drops to be printed to make an optimal pattern of cyan drops, subject to the constraint of making an optimal pattern of the total number of cyan and magenta drops. As another example, if the drop types include large and small drops, the third spread function will have as an input the number of large drops to be printed.

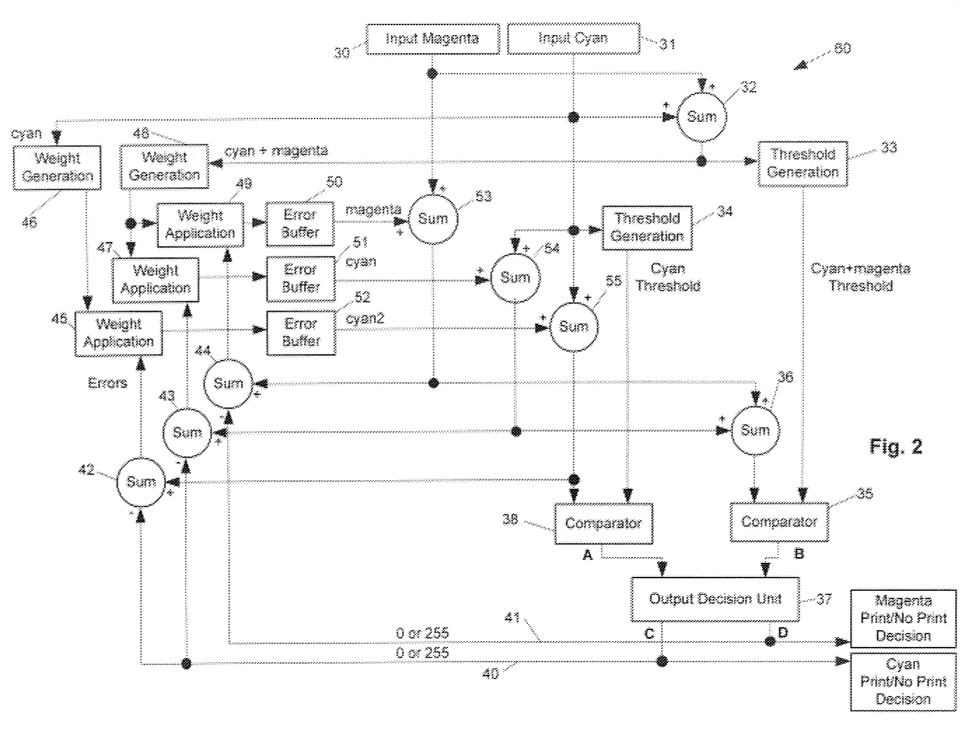

FIG. 2 is a block diagram of a printing system 60 in accordance with a first embodiment of the present invention for making a print decision based on a magenta input 30 and a cyan input 31 for a specific pixel location. System 60 includes two threshold generators 33 and 34, each of which is input-dependent (rather than constant) based on pixel input values 30 and/or 31 using known methods. One such example of an input-dependent threshold generator is disclosed in Ostromoukhov, “A Simple and Efficient Error-Diffusion Algorithm”, ACM Siggraph (Aug. 12-17, 2001) (“Ostromoukhov”). Threshold generator 33 receives as an input the sum of inputs 30 and 31 from adder 32 and outputs a “cyan+magenta threshold”, while threshold generator 34 receives cyan input 31 and outputs a “cyan threshold”.

System 60 further includes a pair of comparators 35 and 38. Comparator 38 compares an output of adder 55 (i.e., the sum of input cyan 31 and a previously calculated error diffusion value from an error buffer 52) with the cyan threshold. If the output of adder 55 is greater, comparator 38 outputs a “1” on output A. Otherwise, comparator 38 outputs a “0” on output A.

Comparator 55 compares an output of adder 36 (i.e., the sum of the outputs of adders 53 and 54) with the cyan+magenta threshold. If the output of adder 36 is greater, comparator 35 outputs a “1” on output B. Otherwise, comparator 35 outputs a “0” on output B.

An output decision unit 37 makes a decision to print or not print a cyan or magenta drop based on inputs A and B. A print decision of a cyan drop generates a 255 on output C, line 40, and a no print decision generates a 0 on output C. A print decision of a magenta drop generates a 255 on output D, line 41, and a no print decision generates a 0 on output D. Table 1 below discloses the outputs on C and D based on the inputs on A and B for one embodiment of output decision unit 37.

TABLE 1

| A | B | C | D |
|---|---|---|---|
| 0 | 0 | 0 | 0 |
| 0 | 1 | 0 | 255 |
| 1 | 0 | 0 | 0 |
| 1 | 1 | 255 | 0 |

The outputs on C (i.e., 0 or 255) are subtracted in adders 42 and 43 from the outputs of adders 55 and 54, respectively. The outputs on D (i.e., 0 or 255) are subtracted in adder 55 from the outputs of adder 53, respectively. The outputs of adders 42-44 are then received by error weight application modules 45, 47 and 49, respectively. Weight generation module 46 generates spread error weight values to error weight application module 45. Weight generation module 48 generates spread error weight values to error weight application modules 47 and 49. Both error weight generation modules 46 and 48 are input-dependent. Weight generation module 46 uses cyan 31 as input, while weight generation module 48 uses the sum of cyan 31 and magenta 30 as input. An example of an input-dependent error weigh generation module is disclosed in Ostromoukhov.

The outputs of weight application modules 45, 47 and 49 are stored in error buffers 52, 51 and 50, respectively, to be used in spreading the error in the next pixel calculation.

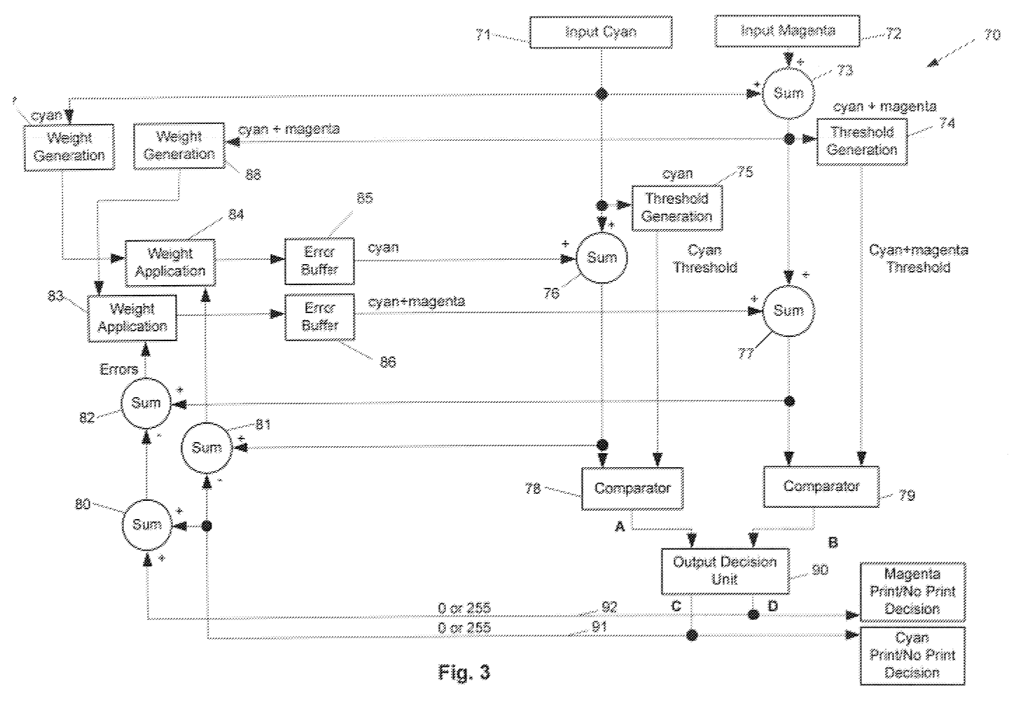

In FIG. 2 three instances of diffusion are used so that three error buffers 50-52 are included to operate the three different spread functions. If memory is constrained, then as shown in FIG. 3, a second embodiment of the invention, one of the error buffers can be removed.

FIG. 3 is a block diagram of a printing system 70 in accordance with a second embodiment of the present invention for making a print decision based on a magenta input 72 and a cyan input 71 for a specific pixel location that includes only two error buffers. System 70 includes two threshold generators 74 and 75, each of which is input-dependent (rather than constant) based on pixel cyan and magenta input values 71 and/or 72 using known methods. Threshold generator 74 receives as an input the sum of inputs 71 and 72 from adder 73 and outputs a “cyan+magenta threshold”, while threshold generator 75 receives cyan input 71 and outputs a “cyan threshold”.

System 70 further includes a pair of comparators 78 and 79. Comparator 78 compares an output of adder 76 (i.e., the sum of input cyan 71 and a previously calculated error diffusion value from an error buffer 85) with cyan threshold. If the output of adder 76 is greater, comparator 78 outputs a “1” on output A. Otherwise, comparator 78 outputs a “0” on output A.

Comparator 79 compares an output of adder 77 (i.e., the sum of the outputs of adder 73 and an error buffer 86) with cyan+magenta threshold. If the output of adder 77 is greater, comparator 79 outputs a “1” on output B. Otherwise, comparator 79 outputs a “0” on output B.

An output decision unit 90 makes a decision to print or not print a cyan or magenta drop based on inputs A and B. A print decision of a cyan drop generates a 255 on output C, line 91, and no print decision generates a 0 on output C. A print decision of a magenta drop generates a 255 on output D, line 92, and a no print decision generates a 0 on output D. Table 2 below discloses the outputs on C and D based on the inputs on A and B for one embodiment of output decision unit 90.

TABLE 2

| A | B | C | D |
|---|---|---|---|
| 0 | 0 | 0 | 0 |
| 1 | 0 | 0 | 0 |
| 0 | 1 | 0 | 255 |
| 1 | 1 | 255 | 0 |

In adder 80, the output on C (i.e., 0 or 255) is added to the output on D (i.e., 0 or 255). In adder 81, the output on C is subtracted from the output of adder 76. In adder 82, the output of adder 80 is subtracted from the output of adder 77. The outputs of adders 81 and 82 are received by error weight application modules 84 and 83, respectively. Two weight generation modules 87 and 88 generate spread error weight values to error weight application modules 84 and 83, respectively. Both error weight generation modules 87 and 88 are input-dependent. Weight generation module 87 uses cyan 71 as input, while weight generation module 88 uses the output of adder 73, the sum of cyan 71 and magenta 72 as input.

The outputs of weight application modules 83 and 84 are stored in error buffers 86 and 85, respectively, to be used in spreading the error in the next pixel calculation.

As disclosed, embodiments of the present invention allow both the combined and individual color planes to meet the pattern quality criteria. In general, embodiments of the present invention are similar to the prior art when deciding when to print a drop, but once it is decided to print a drop, use more intelligence in deciding what type of drop (i.e., cyan or magenta) to print.

The foregoing description of some embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. An apparatus for halftoning an color image comprising first and second primary colors, said apparatus comprising:
a first input-dependent threshold generator receiving the first color as a first threshold input; and
a second input-dependent threshold generator receiving a sum of the first color and the second color as a second threshold input.

2. The apparatus of claim 1, further comprising:
a first input-dependent error weight generation module receiving the first color as a first error weight input; and
a second input-dependent error weight generation module receiving the sum of the first color and the second color as a second error weight input.

3. The apparatus of claim 1, wherein the first primary color is cyan and the second primary color is magenta.

4. The apparatus of claim 1, further comprising:
a first weight application module coupled to the first error weight generation module and
a second weight application module coupled to the second error weight generation module.

5. The apparatus of claim 4, further comprising:
a third weight application module coupled to the second error weight generation module.

6. The apparatus of claim 1, wherein the first and second primary colors each comprise eight bits.

7. The apparatus of claim 1, further comprising a first comparator coupled to said first threshold generator and a second comparator coupled to said second threshold generator.

8. The apparatus of claim 7, further comprising an output decision unit coupled to said first and second comparators, said output decision unit adapted to determine whether to print said first primary color and whether to print the second primary color based on outputs from said first and second comparators.

9. A method of halftoning an color image comprising first and second primary colors, said method comprising:
generating a first threshold based on the first color; and
generating a second threshold based on a sum of the first color and the second color.

10. The method of claim 9, further comprising:
generating a first error weighting based on the first color; and
generating a second error weighting based on the sum of the first color and the second color.

11. The method of claim 9, wherein the first primary color is cyan and the second primary color is magenta.

12. The method of claim 9, further comprising:
comparing the first threshold with a sum of the first color and a first error value to generate a first comparison; and
comparing the second threshold with a sum of the second color and a second error value to generate a second comparison.

13. The method of claim 12, further comprising determining whether to print said first primary color and whether to print the second primary color based on said first and second comparisons.

14. The method of claim 10, further comprising:
generating a first error spread by applying the first error weighting; and
generating a second error spread by applying the second error weighting.

15. The method of claim 14, further comprising:
generating a third error spread by applying the second error weighting.

16. A method of halftoning a color image comprising:
calculating a first digital value for a first color and a second digital value for a second color of the color image;
generating a first error weighting based on the first digital value; and
generating a second error weighting based on the sum of the first digital value and the second digital value.

17. The method of claim 16, further comprising:
generating a first threshold based on the first digital value; and
generating a second threshold based on the sum of the first digital value and the second digital value.

18. The method of claim 16, wherein the first color is cyan and the second color is magenta.

19. The method of claim 18, wherein the first digital value and the second digital value is eight bits.

20. The method of claim 17, further comprising:
determining whether to print a color drop; and
if it is determined to print a color drop, determining whether to print the first color or the second color.
